(19) United States
(12) Patent Application Publication
(10) Pub. No.: US 2024/0240685 A1
(43) Pub. Date: Jul. 18, 2024

(54) Brake Comprising a Device for Ascertaining a Wear Limit

(71) Applicant: Zollern GmbH & Co. KG, Herbertingen/Württ (DE)

(72) Inventor: Harald Schlieske, Mengen (DE)

(73) Assignee: Zollern GmbH & Co. KG, Herbertingen/Württ (DE)

(21) Appl. No.: 18/410,114

(22) Filed: Jan. 11, 2024

(30) Foreign Application Priority Data
Jan. 13, 2023 (DE) 102023100789.0

(51) Int. Cl. F16D 66/02; F16D 55/00; F16D 55/38; F16D 59/00; F16D 65/00; F16D 65/853; F16D 66/00

(52) U.S. Cl. CPC F16D 66/025; F16D 55/38; F16D 59/00; F16D 2055/0033; F16D 2055/0041; F16D 65/0081; F16D 65/853; F16D 2066/003

(57) ABSTRACT

A brake (1) with a device for ascertaining a wear limit, the brake (1) comprising: a pressure piece unit (10) comprising a pressure piece (12) designed to press at least one first brake body (3) and at least one second brake body (4) against each other for applying the brake; and a sensor (20) designed to detect a positional relationship between itself and a detection surface (11) of the pressure piece unit (10), wherein if the brake (1) has not reached its wear limit, the positional relationship between the sensor (20) and the detection surface (11) does not change during a movement of the pressure piece (12) in a first direction, and if the brake (1) has reached its wear limit, the positional relationship between the sensor (20) and the detection surface (11) changes during the movement of the pressure piece (12) in the first direction.

The invention relates to a brake, such as for example a multi-disc brake, comprising a device for ascertaining a wear limit. The brake can preferably be embodied as a holding brake or alternatively as a service brake, for example for locking (holding brake) or slowing (service brake) a cable winch. The cable winch can be part of a construction machine, such as for example a cable excavator or a crane. In general terms, the brake can be used for a traction drive or a drive for a cable winch, slewing ring or tunnelling machine.

Brakes and/or their brake bodies and brake linings are subject to a certain amount of wear. A certain amount of wear does not compromise the functioning of the brake as long as it remains within a wear limit. If the wear limit is reached, the brake or at least its brake bodies should be replaced.

Devices for ascertaining a wear limit in a brake, for example by means of sensors, are known in their own right. In the known solutions, the sensor is arranged such that it is separated from oil situated in the interior of the brake and from lining abrasion coming from the brake bodies, thus avoiding any malfunction of the sensor. Such solutions are however structurally complex and require installation space.

The present invention is based on the object of specifying a brake comprising a device for ascertaining a wear limit of brake bodies and/or their brake linings, which is structurally simple and has a space-saving design and which also reliably ascertains the wear limit.

This object is achieved by the brake comprising the features of claim 1. Advantageous developments follow from the dependent claims, the description and the figures.

The brake comprises a housing, at least a first brake body such as for example one or more first brake bodies, at least a second brake body such as for example one or more second brake bodies, and a pressure piece unit comprising a pressure piece which can be moved relative to the housing in a first direction in order to press the at least one first brake body and the at least one second brake body against each other for the purpose of braking, i.e. to apply the brake, and in a second direction which is opposite to the first direction in order to release the brake. In a multi-disc brake, the first and second brake bodies can be embodied as brake discs.

A first brake body can for example be arranged between two second brake bodies. Alternatively or additionally, a second brake body can be arranged between two first brake bodies. The braking effect between the at least one first brake body and the at least one second brake body is based on a frictional engagement caused by the force with which the pressure piece presses the at least one first brake body and the at least one second brake body against each other. The more forcefully the pressure piece presses the first and second brake bodies against each other, the greater the frictional force and the braking effect of the brake.

The at least one first brake body can for example be arranged such that it cannot be rotated about a rotational axis in relation to the housing, in particular on the housing or on a first brake body holder formed on or in front of the housing. The at least one second brake body can be fastened, such that it cannot be rotated, to a second brake body holder. The at least one second brake body and/or the second brake body holder can be rotatable about the rotational axis relative to the housing or relative to the at least one first brake body. The at least one second brake body can be fastened, such that it cannot be rotated, to the second brake body holder.

A detection surface for interacting with a sensor can be formed on the pressure piece unit. The detection surface can for example be formed on the pressure piece or on another part of the pressure piece unit. Said other part of the pressure piece unit, for example a detection body, can for example be arranged such that it can be moved in relation to the pressure piece, for example mounted by the pressure piece such that it can be moved axially. Said part can in particular be mounted such that it can be moved relative to the pressure piece in the first and second directions in which the pressure piece can also be moved. The pressure piece and/or said part can be movable along or parallel to the rotational axis in the first and second directions.

Said part is preferably a detection body, i.e. the pressure piece unit can comprise a detection body which can be moved, in particular axially, relative to the pressure piece and which comprises the detection surface.

The brake also comprises a sensor, such as for example an inductive sensor, a capacitive sensor, a reed switch or a microswitch. The sensor is designed to detect a positional relationship or a change in the positional relationship between itself and the detection surface. In embodiments in which the detection surface is formed by a part or detection body which can be moved relative to the pressure piece, the sensor is preferably fastened to the housing or at least arranged such that it cannot be moved relative to the housing in the first and second directions. In embodiments in which the detection surface is arranged on the pressure piece or on a part which is fixed in relation to the pressure piece, the sensor can preferably be moved axially relative to the housing in the first and second directions.

When the brake bodies and/or their brake linings become worn, this means that the pressure piece can be moved further in the first direction than when they have not yet become worn. The brake is embodied such that if the brake has not reached its wear limit, the positional relationship between the sensor and the detection surface does not change during the movement of the pressure piece in the first direction, in particular up to and into the position of the pressure piece in which the brake is applied, or only changes so insignificantly that the sensor does not respond to the change, i.e. the sensor and the pressure piece do not move axially relative to each other or do so only insignificantly. The technical background is that the sensor, depending on its design, requires a certain movement between the detection surface and the sensor in order for it to respond to the change in position.

If the brake has reached its wear limit, however, the pressure piece can move further in the first direction than when the brake has not yet become worn, in particular until it reaches its position in which the brake is applied, wherein the positional relationship between the sensor and the detection surface changes during the movement of the pressure piece in the first direction due to a relative movement between the sensor and the detection surface, in particular significantly, i.e. substantially enough that the sensor responds to the change in position. In particular, the positional relationship changes by the distance by which the pressure piece can be moved further in the first direction than when the brake has not yet become worn. This change in position can be ascertained accordingly by the sensor, or the sensor responds to this change in position.

The sensor is designed to output a signal, in particular an electrical signal, from which the change in the positional relationship can be ascertained. This electrical signal can for example be fed to a controller or a computer which processes it and for example causes an output device to output an optical or acoustic signal to the machine operator. Other functions can of course also be triggered by the outputted signal.

If the brake has reached its wear limit, the pressure piece can preferably be moved during its movement in the first direction by a first distance, at which the positional relationship between the sensor and the detection surface does not change, and by a second distance at which the positional relationship does change, in particular significantly, due to a relative movement between the sensor and the detection surface.

In embodiments in which the sensor can be moved axially relative to the housing, the sensor can for example move along with the pressure piece by the first distance. At the end of the first distance, the sensor can for example be blocked by an abutment which can in particular be arranged such that it is fixed relative to the housing. If the pressure piece moves by the second distance, the detection surface is moved away from the sensor, which is blocked from moving any further in the first direction, thus changing the positional relationship.

In preferred embodiments, the detection surface is formed on a part, in particular a detection body, which can be moved relative to the brake body, wherein during its movement in the first direction by the first distance, the pressure piece moves relative to the detection body, which in particular rests against the sensor, and the detection body is stationary relative to the sensor. At the end of the first distance, the pressure piece can be blocked from being able to move relative to the detection body, for example by means of an abutment which is for example fixed in relation to the pressure piece and/or formed by the pressure piece, such that the detection body is moved along with the pressure piece by the second distance, thus distancing the detection surface from the sensor, which is fixed relative to the housing, and changing the positional relationship between the sensor and the detection surface.

The pressure piece unit, in particular a detection body, can for example comprise the abutment which is designed to block a movement of the detection body towards the sensor, which is for example fixed relative to the housing, in particular when the brake has become worn.

A spring can for example be provided which tenses, i.e. applies a spring force to, the detection body in a direction towards the sensor. The spring can for example press the detection surface of the detection body against the sensor or a sensor surface of the sensor, in particular when the brake has not yet become worn and/or while the pressure piece moves in the first direction by its first distance. If the brake has become worn and/or has reached its wear limit, i.e. if the pressure piece moves in the first direction by its second distance, the spring can press the detection body against the abutment which is fixed in relation to the pressure piece.

The spring can in particular be supported on the detection body at one end and on the pressure piece at its other end. The spring can be embodied as a coiled spring which acts as a compression spring. Other types of spring are also possible, as long as they can tense the detection body in a direction towards the sensor.

The abutment, which causes the detection body to participate in the movement of the pressure piece in the first direction, in particular by the second distance, can be formed by an abutment part which is accommodated, together with the detection body, in a recess or bore in the pressure piece, the open end of which points towards the sensor. The detection body or a radial protrusion of the detection body can be arranged axially between the abutment part and the pressure piece and can be movable back and forth in the first and second directions. As mentioned, the spring can be supported on the detection body and the pressure piece and/or arranged between the detection body and the pressure piece. The abutment part, which is for example sleeve-shaped, can be arranged radially between the pressure piece and a portion of the detection body which is in particular cylindrical. The detection body can extend through the sleeve-shaped abutment part.

The spring can for example press the detection surface of the detection body onto the sensor which is fixed relative to the housing. The detection surface can in particular rest against the sensor which is fixed relative to the housing, while the pressure piece is moved by its first distance in the first direction. At the end of the first distance, the detection body or its radial protrusion abuts against the abutment which is fixed relative to the pressure piece, thus causing the detection body to participate in the movement of the pressure piece in the first direction and moving the detection surface away from the sensor. The sensor accordingly outputs a signal from which the change in this positional relationship can be ascertained.

The brake forms an accommodating space which, in developments, can be at least partially filled with oil. The pressure piece unit and at least a part of the sensor are arranged in the accommodating space. It has been found that the arrangement of the sensor and the detection surface in accordance with the invention is resilient and reliably ascertains the wear limit. The at least one first brake body and the at least one second brake body can also be arranged in the accommodating space. The brake bodies are at least partially immersed in the oil situated in the accommodating space. The oil preferably serves to reduce the amount of wear on the brake bodies and to cool the brake bodies.

The accommodating space can be enclosed by the housing and the shaft. The accommodating space can be arranged between two shaft gaskets which are each arranged in a gap between the shaft, which is mounted on the housing such that it can be rotated about the rotational axis, and the housing and which seal off the accommodating space.

The brake can also comprise a pressure space which is designed such that when it is pressurised by a fluid, in particular a liquid or a gas, it moves the pressure piece in the second direction. The pressure space can be delineated or enclosed by the housing and the pressure piece, such that the housing and the pressure piece each form a wall of the pressure space on which the pressure of the fluid can exert a force.

At least one biased brake spring can also be provided which acts on the pressure piece, is in particular supported on the pressure piece and the housing, and moves the pressure piece in the first direction when the pressure space is relieved of pressure, and which is tensed by pressurising the pressure space and the resultant movement of the pressure piece in the second direction. The brake spring can thus apply the brake when there is a sudden drop in pressure in the fluid.

The invention has been described on the basis of multiple embodiments and examples. A particularly preferred embodiment is described below on the basis of figures. The features thus disclosed, each individually and in any combination of features, develop the subject matter of the invention. There is shown:

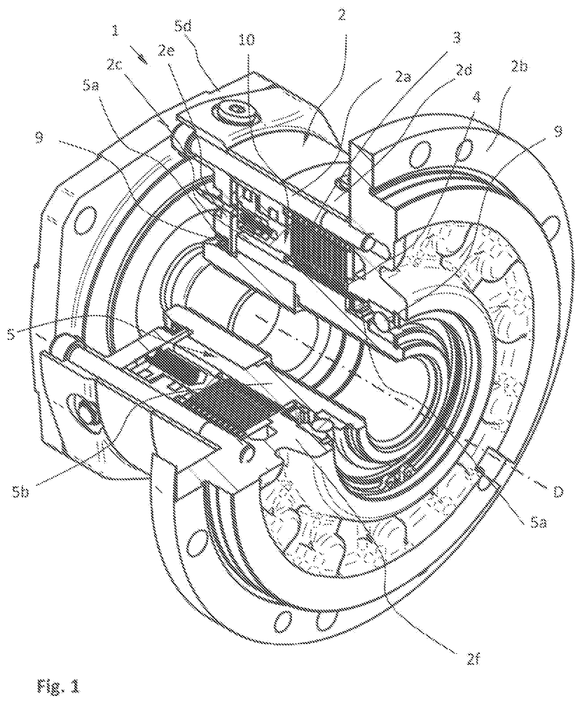

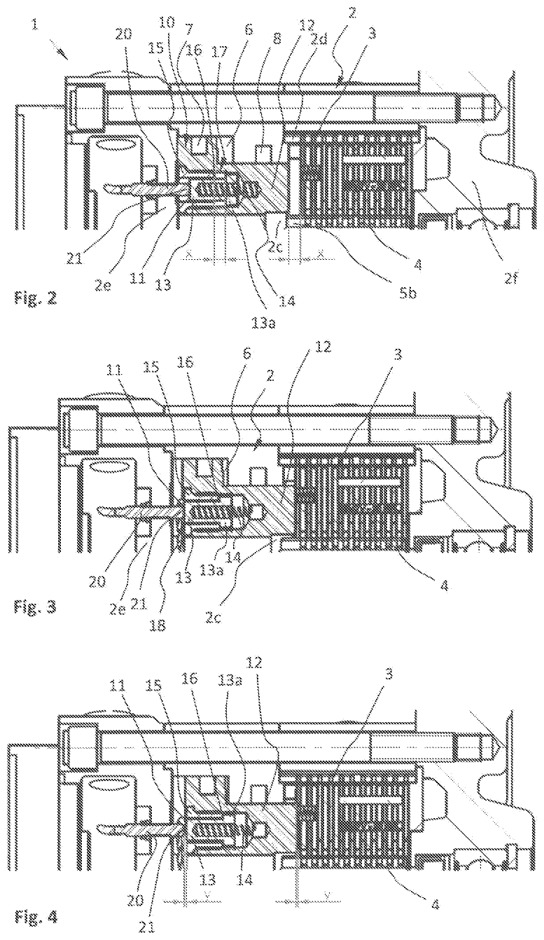

FIG. 1 a perspective view of a brake, in a partial section; FIG. 2 a sectional view of a portion of the brake shown in FIG. 1, wherein the brake is released and has not yet become worn;

FIG. 3 the portion from FIG. 2, wherein the brake is being applied; and

FIG. 4 the portion from FIG. 2, wherein the brake has become worn.

FIG. 1 shows a perspective view of a preferred brake 1 which is embodied as a multi-disc brake. The brake 1 comprises a housing 2 which, as shown in this example, can consist of multiple housing parts. In this example shown, the multiple housing parts are fixedly connected by means of stud bolts 2a. The housing 2 comprises a flange 2b by which the brake 1 can be fastened or flanged to a gear system or other device which can for example be arranged on the driven side of the brake 1.

The brake 1 also comprises a shaft 5, for example a multi-part shaft, which in the example shown is embodied as a hollow shaft and mounted or supported on the housing 2, such that it can be rotated about a rotational axis D, by one or more rotary bearings 9. The housing 2 comprises a first brake body holder 2d, on the inner surface of which multiple first brake bodies 3, in particular first brake discs, are mounted such that they cannot be rotated about the rotational axis D. The shaft 5 comprises a second brake body holder 5b, on the outer surface of which multiple second brake bodies 4, in particular second brake discs, are mounted such that they cannot be rotated about the rotational axis D. When the shaft 5 is rotated about the rotational axis D relative to the housing 2 during operations, the second brake bodies 4 rotate relative to the first brake bodies 3 about the rotational axis D. The brake 1 also comprises a connecting element 5d which in the example shown is embodied as a flange and/or can be part of the housing 2. The connecting element 5d is designed to fasten or flange to it a device which is for example arranged on the drive side of the brake 1, in particular a drive motor or a gear system which is arranged between a drive motor and the brake 1.

The brake 1 also comprises a pressure piece unit 10, the details of which are most clearly shown in FIGS. 2 to 4. The pressure piece unit 10 comprises a pressure piece 12 which can be moved along the rotational axis D in a first direction towards the first and second brake bodies 3, 4 in order to press the brake bodies 3, 4 against each other to achieve a braking effect, i.e. in order to apply the brake 1. The pressure piece 12 can also be moved in a direction opposite to the first direction, in order to move away from the brake bodies 3, 4 to reduce the braking effect and/or release the brake 1.

In the example shown, the brake 1 comprises one or more brake springs 18 (FIG. 3) which are arranged such that they can press the pressure piece 12 in the first direction and apply the brake 1. The at least one brake spring 18 is advantageously supported axially on the pressure piece 12 and the housing 2 or the wall 2e of the housing 2, such that the brake spring 18 biases and/or can move the pressure piece 12 in the first direction.

A pressure chamber 6 which is arranged between the housing 2 and the pressure piece 12 can be pressurised or relieved of pressure by a fluid, for example compressed air or oil. If the pressure chamber 6 is pressurised by a fluid, the pressure piece 12 is moved in the second direction, thus releasing the brake 1 (FIG. 2). If the pressure chamber 6 is relieved of pressure, the at least one brake spring 18 presses the pressure piece 12 in the first direction and applies the brake 1. A first gasket 7 and a second gasket 8, in particular sealing rings, between which the pressure chamber 6 is formed are arranged between an inner circumference of the housing 2 and an outer circumference of the pressure piece 12. The gaskets 7, 8 seal off the pressure chamber 6.

A sensor 20 is attached to the housing 2. The sensor 20 is an inductive sensor in the example shown, but can also be another type of sensor. The housing 2 comprises a wall 2e which extends from an inner circumference radially towards the rotational axis D and comprises a breach in which the sensor 20 is arranged, wherein a part of the sensor 20 or at least its sensor surface 21 is arranged on the side of the wall 2ewhich points towards the pressure piece 12, and a signal line which for example leads to a controller is guided away from the sensor 20 on the other side of the wall 2e. The wall 2e can for example form a seating for one of the rotary bearings 9, via which the shaft is supported on the housing 2, and/or for a shaft sealing ring 5a which seals off an accommodating space 2c from the outside.

The brake 1 forms an accommodating space 2c which extends annularly around the rotational axis D and is enclosed by the housing 2 and the shaft 5. The inner circumference of the housing 2 delineates the accommodating space 2c radially, and the inwardly extending walls 2e, 2f of the housing 2 delineate the accommodating space 2c axially. The accommodating space 2c is arranged between the walls 2e, 2f.

The wall 2f can for example serve as a counter bearing for the force applied to the brake bodies 3, 4 by the pressure piece 12, and/or the brake bodies 3, 4 can be clamped between the pressure piece 12 and the wall 2f. The shaft 5 delineates the accommodating space 2c towards the rotational axis D. The pressure piece unit 10, the first and second brake bodies 3, 4 and at least partially the sensor 20 are arranged in the accommodating space 2c. In order to reduce the amount of wear on the brake bodies 3, 4, the accommodating space 2c can be at least partially filled with oil. Alternatively, the accommodating space can be filled not with oil but rather with gas, in order to avoid excessive heating at high rotational speeds.

The pressure piece 12 comprises a recess 17, in particular a recess 17 shaped as a blind hole or a blind bore, the opening of which points towards the sensor 20. A detection body 13, a spring 14 and a sleeve-shaped abutment part 15 are arranged in the recess 17. The abutment part 15 can for example be screwed, press-fitted or glued into the recess 17. The abutment part 15 is advantageously connected or joined, axially fixed, to the pressure piece 12. The end of the abutment part 15 pointing towards the base of the recess 17 forms an axial abutment 16 for the detection body 13. The detection body 13 comprises an outer circumferential surface via which it can be axially moved and guided on an inner circumferential surface of the sleeve-shaped abutment part 15. The detection body 13 also comprises a projection 13a which is embodied as an annular collar, extends radially outwards and is arranged between the axial abutment 16 and the base of the recess 17. The projection 13a of the detection body 13 can be moved back and forth between the base of the recess 17 and the axial abutment 16 of the abutment part 15. The spring 14 is arranged between the detection body 13 and the base of the recess 17 and biases the detection body 13 in a direction towards the sensor 20. The spring 14 is supported on the detection body 13 and the pressure piece 12. In particular, the spring 14 extends into the sleeve-shaped detection body 13 for the purpose of a compact design and is supported axially on an end-facing wall in the interior of the detection body 13.

When the brake 1 is released, the pressure piece 12 is moved in the second direction (to the left in FIG. 2), wherein the spring 14 presses the detection body 13 against the sensor surface 21 formed on the end-facing side of the sensor 20, and/or the sensor surface 21 of the sensor 20 which is fixed relative to the housing blocks the detection body 13 from moving in the second direction. While the pressure piece 12 is moved together with the abutment part 15 in the second direction, the detection body 13 is stationary in relation to the housing 2 or the sensor 20, thus moving the pressure piece 12 axially relative to the detection body 13, wherein the spring 14 is tensed. The projection 13a of the detection body 13 withdraws from the axial abutment 16 by a distance x which can (but need not) correspond, as shown in the example, to the distance by which the pressure piece 12 withdraws from the brake bodies 3, 4. When the brake 1 is applied (FIGS. 3 and 4), the pressure piece 12 is moved in the first direction relative to the housing 2, wherein the relaxing spring 14 holds the detection surface 11 of the detection body 13 pressed against the sensor 20, while the pressure piece 12 moves axially together with the abutment part 15 relative to the detection body 13. If the brake 1 and/or the brake bodies 3, 4 have not yet become worn, the brake 1 is applied, i.e. the desired braking effect is achieved, before the projection 13a of the detection body 13 abuts against the axial abutment 16 or has abutted against the axial abutment 16 and the pressure piece 12 has entrained the detection body 13 only so far, such that the sensor 20 has not yet detected any change in position between the detection surface 11 and the sensor 20 (FIG. 3). The brake 1 has therefore not yet become worn or only to such an extent that the wear limit has not yet been reached.

If the brake 1 has become worn to such an extent that the wear limit is reached, the axial abutment 16 of the abutment part 15 abuts against the detection body 13, in particular the projection 13a, during the movement of the pressure piece 12 in the first direction while the brake 1 is being applied, in particular at the end of the first distance x, and entrains the detection body 13 by a distance y (FIG. 4), thus withdrawing the detection surface 11 from the sensor 20 and/or its sensor surface 21 by said distance y, wherein the distance y and/or the change in the positional relationship is large enough that the sensor responds to this change in the positional relationship and outputs a signal from which the change in the positional relationship can be ascertained.

### List of Reference Signs

1 brake
2 housing
2a stud bolt
2b flange
2c accommodating space
2d first brake body holder
2e (first) wall
2f (second) wall
3 first brake bodies
4 second brake bodies
5 (hollow) shaft
5a shaft sealing ring
5b second brake body holder
5d connecting element
6 pressure space
7 first gasket
8 second gasket
9 rotary bearings
10 pressure piece unit
11 detection surface
12 pressure piece
13 detection body
13a radial projection/collar
14 spring
15 abutment part
16 axial abutment
17 recess
18 brake spring
20 sensor
21 sensor surface
x distance moved
y distance moved when the wear limit is reached
D rotational axis

1. A brake comprising a device for ascertaining a wear limit, the brake comprising:
a housing;
at least one first brake body, at least one second brake body and a pressure piece unit comprising a pressure piece which can be moved relative to the housing in a first direction in order to press the at least one first brake body and the at least one second brake body against each other for the purpose of braking and in a second direction in order to release the brake; and
a sensor designed to detect a positional relationship between itself and a detection surface formed on the pressure piece unit, wherein
if the brake has not reached its wear limit, the positional relationship between the sensor and the detection surface does not change during the movement of the pressure piece in the first direction, and
if the brake has reached its wear limit, the positional relationship between the sensor and the detection surface changes during the movement of the pressure piece in the first direction due to a relative movement between the sensor and the detection surface.

2. The brake according to claim 1, wherein the sensor is an inductive sensor, a capacitive sensor, a reed switch or a microswitch.

3. The brake according to claim 1, wherein the sensor is designed to output a signal from which the change in the positional relationship can be ascertained.

4. The brake according to claim 1, wherein if the brake has reached its wear limit, the pressure piece can be moved during its movement in the first direction by a first distance, at which the positional relationship between the sensor and the detection surface does not change, and by a second distance at which the positional relationship does change due to a relative movement between the sensor and the detection surface.

5. The brake according to claim 1, wherein the pressure piece unit comprises a detection body which can be moved relative to the pressure piece, and which comprises the detection surface.

6. The brake according to claim 5, wherein the pressure piece unit comprises an abutment which is designed to block a movement of the detection body towards the sensor.

7. The brake according to claim 6, wherein the sensor is fixed relative to the housing.

8. The brake according to claim 5, wherein the pressure piece unit also comprises a spring which tenses the detection body in a direction towards the sensor.

9. The brake according to claim 6, wherein the abutment is formed by an abutment part which is accommodated, together with the detection body, in a recess or bore in the pressure piece, wherein the detection body is arranged axially between the abutment part and the pressure piece, and the spring is supported on the detection body and the pressure piece.

10. The brake according to claim 8, wherein the spring presses the detection surface of the detection body onto the sensor which is fixed relative to the housing, while the pressure piece is moved by a first distance in the first direction, wherein at the end of the first distance, the detection body abuts against an abutment which is fixed relative to the pressure piece, thus causing the detection body to participate in the movement of the pressure piece in the first direction and moving the detection surface away from the sensor by a second distance.

11. The brake according to claim 9, wherein the spring presses the detection surface of the detection body onto the sensor which is fixed relative to the housing, while the pressure piece is moved by a first distance in the first direction, wherein at the end of the first distance, the detection body abuts against an abutment which is fixed relative to the pressure piece, thus causing the detection body to participate in the movement of the pressure piece in the first direction and moving the detection surface away from the sensor by a second distance.

12. The brake according to claim 1, wherein the housing and a shaft, which is mounted such that it can be rotated about the rotational axis relative to the housing and to which the at least one second brake body is connected such that it cannot be rotated, enclose an accommodating space which is at least partially filled with oil, wherein the pressure piece unit and at least partially the sensor are arranged in the accommodating space.

13. The brake according to claim 12, wherein the at least one first brake body and the at least one second brake body are arranged in the accommodating space.

14. The brake according to claim 1, further comprising a second brake body holder which can be rotated about a rotational axis relative to the housing, wherein the at least one first brake body is fastened, such that it cannot be rotated, to the housing or to a first brake body holder, and the at least one second brake body is fastened, such that it cannot be rotated, to the second brake body holder.

15. The brake according to claim 1, further comprising a pressure space which is designed such that when it is pressurised by a fluid, it moves the pressure piece in the second direction.

16. The brake according to claim 15, further comprising at least one biased brake spring which acts on the pressure piece and moves the pressure piece in the first direction when the pressure space is relieved of pressure, and which is tensed by pressurising the pressure space and the resultant movement of the pressure piece in the second direction.
